(19) United States
(12) Patent Application Publication
(10) Pub. No.: US 2020/0103060 A1
(43) Pub. Date: Apr. 2, 2020

(54) COMPOSITE METAL AND POLYMER PIPE COUPLING

(71) Applicant: American Cast Iron Pipe Company, Birmingham, AL (US)

(72) Inventor: Ronald Hayes, Trussville, AL (US)

(21) Appl. No.: 16/148,179

(22) Filed: Oct. 1, 2018

(51) Int. Cl. F16L 19/00

(52) U.S. Cl. CPC F16L 19/00

(57) ABSTRACT

A composite metal and polymer pipe coupling is provided. Embodiments include a coupling having a metal pipe body, and a rigid polymer liner affixed to and completely covering an inside surface of the pipe body. Opposite ends of the liner each have a circumferential raised end section extending toward a longitudinal axis of the pipe body. The liner also has a circumferential pipe buttress near a middle of the liner extending toward the longitudinal axis. An elastomeric gasket engages the liner adjacent an interior side of each of the raised end sections of the liner. The raised end sections are each configured to receive and hold the end of a pipe centered relative to the pipe body, such that its corresponding gasket seals the pipe end around an entire circumference of the pipe end when the pipe is inserted into the coupling until it contacts the pipe buttress.

### FIELD

Embodiments relate generally to pipe couplings and methods of manufacture thereof. Embodiments relate to composite metal and polymer pipe couplings.

### SUMMARY

One or more embodiments can include a composite pipe coupling with a pipe body comprising a cylindrical metal pipe having a longitudinal axis. A substantially rigid polymer liner having an internal section is affixed to and completely covers an inside surface of the pipe body, the liner including opposite ends extending at least to respective circumferential ends of the pipe body. Each of the opposite ends of the internal section of the liner include a circumferential raised end section adjacent one of the respective ends of the pipe body, each raised end section radially extending away from the internal section of the liner toward the longitudinal axis of the pipe body. The liner further includes a circumferential pipe buttress radially extending away from substantially a middle of the internal section of the liner toward the longitudinal axis of the pipe body, the pipe buttress extending past a height of the raised end sections. A pair of elastomeric gaskets each fixedly engages the internal section of the liner adjacent an interior side of one of the raised end sections. Each of the respective raised end sections of the liner is configured to receive and hold a pipe end of a pipe substantially centered relative to the pipe body such that its corresponding gasket seals the pipe end around an entire circumference of the pipe end when the pipe is inserted into the coupling until it contacts the pipe buttress.

Embodiments can further include a method of manufacturing a composite pipe coupling. The method comprises comprising providing a pipe body including a cylindrical metal pipe with a longitudinal axis; and molding a substantially rigid polymer liner with an internal section circumferentially around and affixed to an inner diameter of an entire inside surface of the pipe body. The liner includes opposite ends extending at least to respective circumferential ends of the pipe body, each of the opposite ends of the internal section of the liner including a circumferential raised end section adjacent one of the respective ends of the pipe body. Each raised end section extends radially away from the internal section of the liner toward the longitudinal axis of the pipe body. The liner further includes a circumferential pipe buttress radially extending away from substantially a middle of the internal section of the liner toward the longitudinal axis of the pipe body, the pipe buttress extending past a height of the raised end sections. The method further includes providing a pair of elastomeric gaskets, each gasket fixedly engagable with the internal section of the liner adjacent to an interior side of one of the raised end sections. Each of the respective raised end sections of the liner is configured to receive and hold a pipe end of a pipe substantially centered relative to the pipe body such that its corresponding gasket seals the pipe end around an entire circumference of the pipe end when the pipe is inserted into the coupling until it contacts the pipe buttress.

Objects and advantages of embodiments of the disclosed subject matter will become apparent from the following description when considered in conjunction with the accompanying drawings.

### BRIEF DESCRIPTION OF THE DRAWINGS

Embodiments will hereinafter be described in detail below with reference to the accompanying drawings, wherein like reference numerals represent like elements. The accompanying drawings have not necessarily been drawn to scale. Where applicable, some features may not be illustrated to assist in the description of underlying features.

FIG. 1 is a perspective view diagrammatically illustrating an exemplary pipe coupling according to various embodiments.

FIG. 2 is a partial cross-sectional view of the pipe coupling of FIG. 1.

FIG. 3 is a partial cross-sectional view of the pipe coupling of FIG. 1 with two pipes that the coupling is joining to each other.

### DETAILED DESCRIPTION

It should be understood that the principles described herein are not limited in application to the details of construction or the arrangement of components set forth in the following description or illustrated in the following drawings. The principles can be embodied in other embodiments and can be practiced or carried out in various ways. Also, it is to be understood that the phraseology and terminology used herein is for the purpose of description and should not be regarded as limiting.

Disclosed herein are composite metal and polymer pipe couplings and methods of manufacturing these couplings. The disclosed couplings combine the strength and durability of metal pipes (typically ductile iron or steel) with the inertness and formability of polymers, to provide an inexpensive and versatile coupling used to join two pipes, such as two ductile cast iron pipes. To manufacture the disclosed coupling, a short piece of standard sized and commonly available metal pipe is utilized, and a multifunction polymer liner is injection molded inside the metal pipe. Gaskets comprising vulcanized rubber or polymer are then formed separately and manually inserted in the liner. In the alternative, polymer gaskets are formed in place by injection molding the gaskets to the liner.

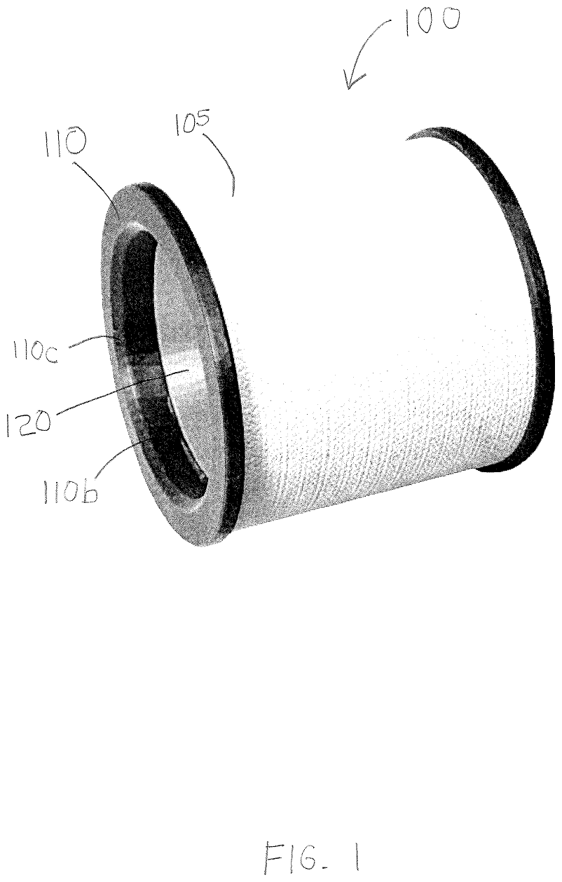

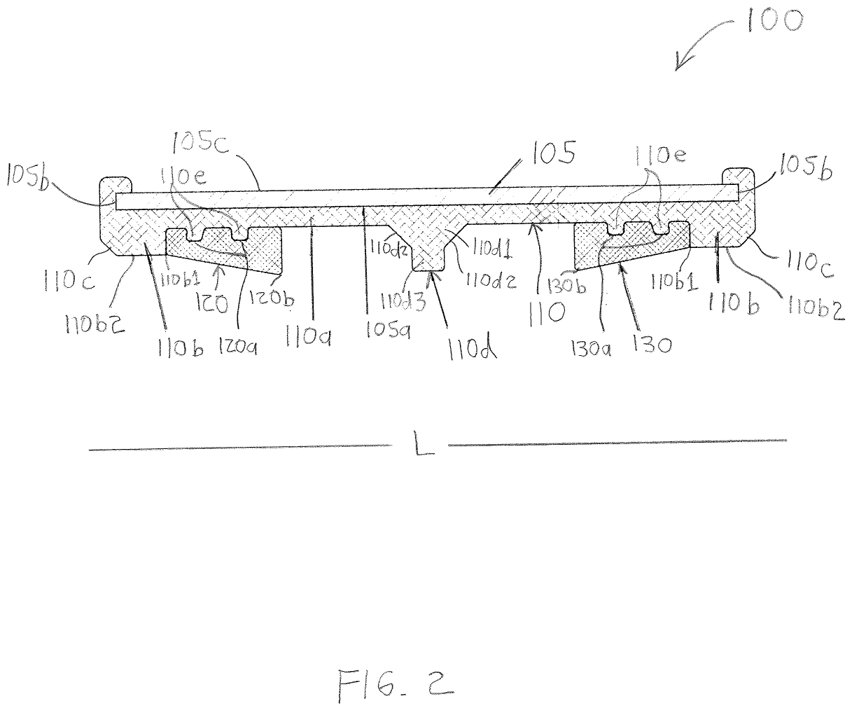

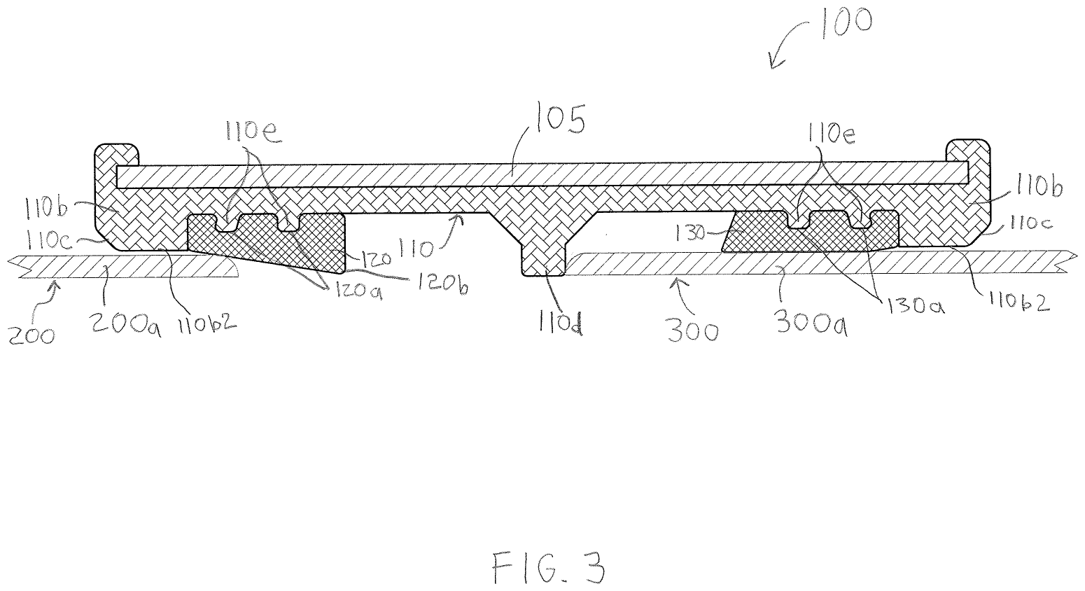

An exemplary embodiment of a composite coupling 100 according to the present disclosure will now be described with reference to FIGS. 1 and 2. FIG. 3 shows the disclosed coupling 100 of FIGS. 1 and 2 joining two metal pipes 200, 300, such as ductile cast iron pipes. In FIG. 3, pipe 200 is shown partially inserted into coupling 100, and pipe 300 is shown fully inserted into coupling 100. As shown in FIGS. 1 and 2, composite pipe coupling 100 comprises a pipe body 105 comprising a cylindrical metal pipe having a longitudinal axis L, such as a ductile iron or steel pipe. The metal pipe body 105 provides the necessary hoop strength and ring strength needed to resist the stresses due to internal pressures and external loads typical of buried pipelines.

A substantially rigid polymer liner 110 having an internal section 110a is affixed to and completely covers an inside surface 105a of the pipe body 105, its opposite ends extending at least to respective circumferential ends 105b of the pipe body 105. In the illustrated embodiment, the liner 110 extends over and around the respective ends 105b of the pipe body 105, and further extends onto, around, and affixed to an outside surface 105c of the pipe body 105 adjacent the respective ends 105b of the pipe body 105. Each of the opposite ends of the internal section 110a of the liner 110 includes a circumferential raised end section 110b adjacent one of the respective ends 105b of the pipe body 105. Each raised end section 110b extends radially away from the internal section 110a of the liner 110 toward the longitudinal axis L of the pipe body, and includes an outer chamfered edge 110c to facilitate receiving an end 200a, 300a of one of the pipes 200, 300 to be joined by the coupling 100.

The liner 110 also includes a circumferential pipe buttress 110d radially extending away from substantially a middle of the internal section 110a of the liner 110 toward the longitudinal axis L of the pipe body 105. The pipe buttress 110d has a base with a substantially triangular-shaped cross-section 110d1, with opposing walls 110d2 extending away from the internal section of the liner 110a and inwardly toward each other. Each wall 110d2 connects to a top portion 110d3 having a substantially rectangular-shaped cross-section. Pipe buttress 110d extends past a height of the raised end sections 110b, as best seen in FIG. 3, showing that when a pipe 300 is fully inserted into coupling 100, pipe buttress 110d contacts the pipe end 300a while the outside of pipe 300 is proximal a top surface 110b2 of the raised end section 110b. The pipe buttress 110d is configured to longitudinally align the two pipe ends 200a, 300a when the two pipes 200, 300 are fully inserted into opposing ends of the pipe body 105. In other words, pipe buttress 110d insures both pipe ends 200a, 300a are fully and equally inserted into the coupling 100.

In certain embodiments, the liner 110 comprises high density polyethylene (HDPE), and has a Shore “A” durometer hardness of between about 75 to 100; for example, around 85+/−5.

A pair of elastomeric gaskets 120, 130 is provided, each gasket fixedly engaging the internal section 110a of the liner 110 adjacent an interior side 110b1 of one of the raised end sections 110b. Each gasket 120, 130 further comprises one or more circumferential grooves 120a, 130a formed in an outer surface of the gasket 120, 130, each groove configured to engage a reciprocally-shaped circumferential ridge 110e extending radially inwardly (i.e., towards longitudinal axis L of pipe body 105) from an inside surface of the internal section 110a of the liner 110. An inside corner 120b, 130b of each gasket 120, 130 remote from a respective adjacent raised end section 110b of the internal section 110a of the liner 110 extends away from the internal section 110a of the liner towards the longitudinal axis L of the pipe body 105 to a height greater than the top surface 110b2 of each of the raised end sections 110b.

Each of the pair of gaskets 120, 130 has a Shore “A” durometer hardness of between about 45 to 90; for example, around 60+/−5. In certain embodiments, the gaskets 120, 130 comprise vulcanized rubber, such as a conventional ethylene propylene diene monomer (EDPM) rubber, and are formed separately from the liner 110 and manually inserted into the liner 110 using conventional techniques. In alternative embodiments, the gaskets 120, 130 instead comprise a polymer and are either formed separately from the liner 110 and manually inserted, or injection molded onto the liner 110, as explained in greater detail herein below. The use of a polymer as the gasket material is advantageous due to the inertness of polymers, and their reduced cost compared to vulcanized rubber. Materials which could be used to make the gaskets 120, 130 include polyurethane; polypropylene; a thermoplastic vulcanizate (TPV) elastomer including polypropylene with EDPM rubber; and a thermoplastic having a hardener to get the desired ASTM value, but not cross-linked like vulcanized rubber.

Referring again to FIG. 3, each of the respective raised end sections 110b of the liner 110 is configured to receive and hold a pipe end 200a, 300a of a pipe 200, 300 substantially centered relative to the pipe body 105 such that its corresponding gasket 120, 130 seals the pipe end 200a, 300a around an entire circumference of the pipe end 200a, 300a when the pipe 200, 300 is inserted into the coupling 100 until it contacts the pipe buttress 110d. The right side of FIG. 3 shows pipe 300 fully inserted into coupling 100; that is, contacting pipe buttress 110d and compressing gasket 130 to seal pipe end 300a. The left side of FIG. 3 shows pipe 200 partially inserted into coupling 100; it has not yet compressed gasket 120.

Thus, the injection molded polymer liner 110 performs the functions of 1) holding and restraining the gaskets 120, 130 in position during joint assembly and while under pressure during service; 2) holding the joining pipe ends 200a, 300a substantially centered in the coupling 100 to insure the gaskets 120, 130 seal the full 360° around the ends 200a, 300a of the pipes 200, 300; 3) providing a buttress/stop 110d at the inside center of the coupling 100 to insure both pipe ends 200a, 300a are fully and equally inserted into the coupling 100; 4) providing a watertight membrane; and 5) providing an inert liner to protect the metal coupling body 105 against chemical attack from the conveyed fluid.

The disclosed coupling 100 has deflection capability dependent on coupling length, similar to conventional couplings. Coupling 100 has what is known in the art as “push-on” type pipe joints, and those of skill in the art will understand that the joint deflection capability of coupling 100 (i.e., the maximum achievable angle between the longitudinal centerlines of the two joined pipes 200, 300) is determined by its “socket depth.” The socket depth is the amount the pipe ends 200a, 300a of pipes 200, 300 extend into the coupling 100. Socket depth is largely determined by the length of the coupling. For example, in the present case, the socket depth is a bit less than half the length of pipe body 105.

A method of manufacturing the disclosed pipe coupling 100 includes providing the pipe body 105, and molding the substantially rigid polymer liner 110 to the pipe body 105, as by injection molding in a conventional manner. The liner 110 is molded in one piece with its above-discussed internal section 110a circumferentially around and affixed to an inner diameter of the entire inside surface 105a of the pipe body 105. As also discussed herein above, in the described embodiment opposite ends of the internal section 110a of the liner 110 extend at least to the respective circumferential ends 105b of the pipe body 105, extend over and around the respective ends 105b of the pipe body 105, and extend onto, around, and affixed to an outside surface 105c of the pipe body 105 adjacent the respective ends 105b of the pipe body 105. Each of the opposite ends of the internal section 110a of the liner molding include a circumferential raised end section 110b adjacent one of the respective ends 105b of the pipe body 105, each raised section 110b extending radially away from the internal section 110a of the liner 110 toward the longitudinal axis L of the pipe body, and including an outer chamfered edge 110c to facilitate receiving one of the pipe ends 200a, 300a. The one-piece liner molding 110 further includes the circumferential pipe buttress 110d radially extending away from substantially a middle of the internal section of the liner 110 toward the longitudinal axis L of the pipe body past a height of the top surface 110b2 of the raised end sections 110b.

The method further includes providing a pair of the elastomeric gaskets 120, 130, each gasket fixedly engagable with the internal section 110a of the liner 110 adjacent to an interior side 110b1 of one of the raised end sections 110b. As discussed herein above, each of the gaskets 120, 130 has an angled surface extending from an outside corner of the gasket 120, 130 adjacent to an interior side 110b1 of a respective raised end section 110b, to an inside corner 120b, 130b of the gasket 120, 130 remote from the respective raised end section 110b, and the angled surface angles radially inwardly towards the longitudinal axis L of the pipe body from the outside corner to the inside corner 120b, 130b.

Each of the pair of gaskets 120, 130 also has one or more circumferential grooves 120a, 130a, and molding the liner 110 comprises molding circumferential ridges 110e extending radially inwardly (i.e., towards longitudinal axis L of pipe body 105) from an inside surface of the internal section 110a of the liner 110 corresponding to the grooves 120a, 130a of the gaskets 120, 130, the grooves 120a, 130a being configured to receive and be affixed to the corresponding ridges 110e of the liner 110.

In certain embodiments, the gaskets 120, 130 are injection molded to the liner 110 by a second conventional injection molding operation immediately after the injection molding of the liner 110. Thus, providing the pair of gaskets 120, 130 includes injection molding the gaskets 120, 130 into the circumferential ridges 110e of the liner 110. In alternative embodiments, the gaskets 120, 130 are separately manufactured and manually inserted into the ridges 110e of the liner 110. In this case, providing the pair of gaskets 120, 130 comprises manually inserting the grooves 120a, 130a of the gaskets 120, 130 into the circumferential ridges 110e of the liner 110 after molding the liner 110.

As discussed in detail herein above, in some embodiments the gaskets 120, 130 are vulcanized rubber; in such embodiments the gaskets are manufactured separately in a conventional manner and manually inserted. As also discussed herein above, in other embodiments the gaskets 120, 130 comprise a polymer; in such embodiments the gaskets can be manufactured separately as by injection molding, or injection molded to the liner 110. The manufacturing method utilized for the polymer gaskets 120, 130 is determined by the type of polymer required for the coupling application and/or the demands of the coupling's end user(s).

While this invention has been described in conjunction with a number of embodiments, it is evident that many alternatives, modifications and variations would be or are apparent to those of ordinary skill in the applicable arts. Accordingly, applicants intend to embrace all such alternatives, modifications, equivalents and variations that are within the spirit and scope of this invention.

What is claimed is:

1. A composite pipe coupling comprising:
a pipe body comprising a cylindrical metal pipe having a longitudinal axis;
a substantially rigid polymer liner having an internal section affixed to and completely covering an inside surface of the pipe body, the liner including opposite ends extending at least to respective circumferential ends of the pipe body, each of the opposite ends of the internal section of the liner including a circumferential raised end section adjacent one of the respective ends of the pipe body, each raised end section radially extending away from the internal section of the liner toward the longitudinal axis of the pipe body, the liner further including a circumferential pipe buttress radially extending away from substantially a middle of the internal section of the liner toward the longitudinal axis of the pipe body, the pipe buttress extending past a height of the raised end sections; and
a pair of elastomeric gaskets, each gasket fixedly engaging the internal section of the liner adjacent an interior side of one of the raised end sections;
wherein each of the respective raised end sections of the liner is configured to receive and hold a pipe end of a pipe substantially centered relative to the pipe body such that its corresponding gasket seals the pipe end around an entire circumference of the pipe end when the pipe is inserted into the coupling until it contacts the pipe buttress.

2. The composite pipe coupling of claim 1, wherein the pipe buttress comprises a base having a substantially triangular-shaped cross-section with opposing walls extending away from the internal section of the liner and inwardly toward each other, each wall connecting to a top portion having a substantially rectangular-shaped cross-section.

3. The composite pipe coupling of claim 2, wherein the pipe buttress is configured to longitudinally align two of the pipe ends when two of the pipes are inserted into opposing ends of the pipe body.

4. The composite pipe coupling of claim 1, wherein each of the pair of gaskets further comprises one or more circumferential grooves formed in an outer surface of the gasket, each groove configured to engage a reciprocally-shaped circumferential ridge extending radially inwardly from an inside surface of the internal section of the liner.

5. The composite pipe coupling of claim 1, wherein an inside corner of each of the pair of gaskets remote from a respective adjacent raised end section of the internal section of the liner extends away from the internal section of the liner towards the longitudinal axis of the pipe body to a height greater than a top surface of each of the raised end sections.

6. The composite pipe coupling of claim 1, wherein each raised end section of the internal section of the liner includes an outer chamfered edge to facilitate receiving one of the pipe ends.

7. The composite pipe coupling of claim 1, wherein the liner comprises high density polyethylene (HDPE).

8. The composite pipe coupling of claim 1, wherein the liner has a Shore “A” durometer hardness of between about 75 to 100.

9. The composite pipe coupling of claim 8, wherein the liner has a Shore “A” durometer hardness of around 85+/−5.

10. The composite pipe coupling of claim 1, wherein each of the pair of gaskets comprises one of vulcanized rubber and a polymer.

11. The composite pipe coupling of claim 1, wherein each of the pair of gaskets has a Shore “A” durometer hardness of between about 45 to 90.

12. The composite pipe coupling of claim 11, wherein each of the pair of gaskets has a Shore “A” durometer hardness of around 60+/−5.

13. The composite pipe coupling of claim 1, wherein the liner extends over and around the respective ends of the pipe body, and further extends onto, around, and affixed to an outside surface of the pipe body adjacent the respective ends of the pipe body.

14. A method of manufacturing a composite pipe coupling, the method comprising:
providing a pipe body including a cylindrical metal pipe with a longitudinal axis;
molding a substantially rigid polymer liner with an internal section circumferentially around and affixed to an inner diameter of an entire inside surface of the pipe body, the liner including opposite ends extending at least to respective circumferential ends of the pipe body, each of the opposite ends of the internal section of the liner including a circumferential raised end section adjacent one of the respective ends of the pipe body, each raised end section extending radially away from the internal section of the liner toward the longitudinal axis of the pipe body, the liner further including a circumferential pipe buttress radially extending away from substantially a middle of the internal section of the liner toward the longitudinal axis of the pipe body, the pipe buttress extending past a height of the raised end sections; and
providing a pair of elastomeric gaskets, each gasket fixedly engagable with the internal section of the liner adjacent to an interior side of one of the raised end sections;
wherein each of the respective raised end sections of the liner is configured to receive and hold a pipe end of a pipe substantially centered relative to the pipe body such that its corresponding gasket seals the pipe end around an entire circumference of the pipe end when the pipe is inserted into the coupling until it contacts the pipe buttress.

15. The method of claim 14, comprising molding the liner to extend over and around the respective ends of the pipe body and onto, around, and affixed to an outside surface of the pipe body adjacent the respective ends of the pipe body.

16. The method of claim 14, comprising molding the liner such that each raised end section of the internal section of the liner includes an outer chamfered edge to facilitate receiving one of the pipe ends.

17. The method of claim 14, wherein providing the pair of gaskets further comprises providing each of the gaskets with an angled surface extending from an outside corner of the gasket adjacent to a respective raised end section of the internal section of the liner, to an inside corner of the gasket remote from the respective raised end section, wherein the angled surface angles radially inwardly towards the longitudinal axis of the pipe body from the outside corner to the inside corner of the gasket.

18. The method of claim 14, wherein providing the pair of gaskets further comprises providing each of the pair of gaskets with one or more circumferential grooves, and molding the liner comprises molding circumferential ridges extending radially from the internal section of the liner corresponding to the grooves of the gaskets, the grooves of each of the gaskets being configured to receive and be affixed to the corresponding ridges of the liner.

19. The method of claim 18, wherein providing the pair of gaskets comprises injection molding the gaskets into the circumferential ridges of the liner.

20. The method of claim 18, wherein providing the pair of gaskets comprises manually inserting the grooves of the gaskets into the circumferential ridges of the liner after molding the liner.
